(19) United States
(12) Patent Application Publication
(10) Pub. No.: US 2013/0062340 A1
(43) Pub. Date: Mar. 14, 2013

(54) Centrifugal Magnetic Heating Device

(71) Applicant: Wan Chun Hsu, Hsinchu County (TW)

(72) Inventor: Wan Chun Hsu, Hsinchu County (TW)

(21) Appl. No.: 13/606,458

(22) Filed: Sep. 7, 2012

(30) Foreign Application Priority Data
Sep. 14, 2011 (TW) 100132972

(51) Int. Cl. H05B 6/02

(52) U.S. Cl. 219/600

(57) ABSTRACT

A centrifugal magnetic heating device includes a power receiving mechanism and a heat generator. The power receiving mechanism further includes a vane set and a transmission module. The heat generator connected with the transmission module further includes a centrifugal mechanism connected to the transmission module, a plurality of bases furnished on the centrifugal mechanism, a plurality of magnets furnished on the bases individually, and at least one conductive member corresponding in positions to the magnets. The vane set is driven by nature flows so as to drives the bases synchronically with the magnets through the transmission module, such that the magnets can rotate relative to the conductive member and thereby cause the conductive member to generate heat.

This application claims the benefit of Taiwan Patent Application Serial No. 100132972, filed on Sep. 14, 2011, the subject matter of which is incorporated herein by reference.

### BACKGROUND OF INVENTION

1. Field of the Invention

The invention relates to a centrifugal magnetic heating device, and more particularly to the device that utilizes natural flows, such as the wind flow, to drive a power receiving mechanism to further rotate a conductive member in a suspension way inside a centrifugal mechanism and interacting with the stationary magnets of a heat generator for generating heat therefrom.

2. Description of the Prior Art

In the art, the wind turbine power generation system is known to be one of modem environment-friendly power generation systems, which utilizes wind turbines to collect wind power by activating a generator to generate electric energy. Currently, the wind turbine power generation system needs a large number of expensive electronic devices and also has an inacceptable limit in output power. Thus, the wind turbine power generation system can only be seen in a large-scale power supply facilities, and is definitely not popular to ordinary consumers.

Another well-known power generation system is the solar energy system, in which electric energy is obtained from transforming the heat energy. One of the shortcomings in the solar energy system, either a parallel power regeneration system or a direct heating system, is the cost for the energy.

Further, in a conventional solar heat energy system, the solar energy is collected to produce the heat energy. Yet, such a system is highly climate-independent. In the cold winter, poor sunshine usually reduces the collection in solar energy, and as a consequence an auxiliary heating system is required for the dark night usage. Also, obvious disadvantages of the solar system are its space occupation and again the cost.

Accordingly, the present invention is devoted to introducing the wind power to directly produce the thermal energy without any intern transformation step. Thereupon, the complexity in structuring and the cost can be substantially reduced. In the present invention, an obvious advantage can be obtained by waiving the wind power generator, so that cost in coiling and power loss for transformation and internal friction in the generator can thus be avoided. Also, in the present invention, the achievement in simple-structuring, energy saving and environment protection is superior to most of the conventional water heating system in the marketplace. By providing the present invention, no matter what the time is in day or night, as long as there is a wind, there is heated water available. In particular, in the chilly winter or in a polar climate, the water heating system of the present invention can be still prevailed.

### SUMMARY OF THE INVENTION

Accordingly, it is the primary object of the present invention to provide a centrifugal magnetic heating device, which can utilize the wind power to turn a power receiving unit and further to drive a heat generating apparatus that introduces magnet-induced eddy currents to generate heat. By providing the present invention to generate heat, no conventional step in generating electricity prior to generate the comparable thermal energy is needed; and thus complicate wiring structuring in the generator and lousy circuiting for forming the power controlling algorithms in the art can be avoided so as to reduce the cost. Further, the present invention particularly introduces a centrifugal mechanism that can reduce the spacing between the permanent magnets and the electric inducing members while the operational speed is increased. On the other hand, while the operational speed is reduced, the spacing between the permanent magnets and the electric inducing members would be centrifugally enlarged so as to reduce the electromagnetic effect and merely to maintain the heat generation in between.

To achieve the aforesaid purposes, the present invention provides a centrifugal magnetic heating device that includes a power receiving mechanism and a heat generator. The power receiving mechanism further includes a vane set and a transmission module. The heat generator connected with the transmission module further includes a centrifugal mechanism connected to the transmission module, a plurality of bases furnished on the centrifugal mechanism, a plurality of magnets furnished on the bases individually, and at least one conductive member corresponding in positions to the magnets. The vane set is driven by nature flows to further drive the bases as well as the magnets on the bases through the transmission module, such that the magnets can rotate relative to the conductive member through the centrifugal mechanism. Introducing the centrifugal forcing to vary the spacing between the permanent magnets and the conductive member so as to automatically adjust the electromagnetic field in between according to the rotation changes can result in the generation of eddy currents while the magnetic field shielding the conductive member is changed and further generation of the heat induced by the eddy currents on the conductive member.

All these objects are achieved by the centrifugal magnetic heating device described below.

### BRIEF DESCRIPTION OF THE DRAWINGS

The present invention will now be specified with reference to its preferred embodiment illustrated in the drawings, in which:

FIG. 1 is an exploded view of a preferred centrifugal magnetic heating device in accordance with the present invention;

FIG. 2 is a front view of the heat generator of FIG. 1;

FIG. 3 is a lateral view of the heat generator of FIG. 1;

FIG. 4 shows the engagement of the heat generator, the water jacket member and the heat conduction member of FIG. 1;

FIG. 5 is a schematic view showing a first embodiment of the position resuming member of the centrifugal magnetic heating device in accordance with the present invention;

FIG. 6 is a schematic view showing a second embodiment of the position resuming member of the centrifugal magnetic heating device in accordance with the present invention;

FIG. 7 is a schematic view showing a third embodiment of the position resuming member of the centrifugal magnetic heating device in accordance with the present invention;

FIG. 8 is a schematic view showing a fourth embodiment of the position resuming member of the centrifugal magnetic heating device in accordance with the present invention;

FIG. 9 is a schematic view showing a first embodiment in arranging the permanent magnets of the centrifugal magnetic heating device in accordance with the present invention;

FIG. 10 is a schematic view showing a second embodiment in arranging the permanent magnets of the centrifugal magnetic heating device in accordance with the present invention;

FIG. 11 is a schematic view showing a third embodiment in arranging the permanent magnets of the centrifugal magnetic heating device in accordance with the present invention;

FIG. 12 is an exploded view of a first embodiment of the heat generator of the centrifugal magnetic heating device in accordance with the present invention;

FIG. 13 is a cross-sectional view of a first embodiment of the conductive member for the centrifugal magnetic heating device in accordance with the present invention;

FIG. 14 is a cross-sectional view of a second embodiment of the conductive member for the centrifugal magnetic heating device in accordance with the present invention;

FIG. 15 is a cross-sectional view of a third embodiment of the conductive member for the centrifugal magnetic heating device in accordance with the present invention;

FIG. 16 is a cross-sectional view of a first embodiment of the heat generator for the centrifugal magnetic heating device in accordance with the present invention;

FIG. 17 is a cross-sectional view of a second embodiment of the heat generator for the centrifugal magnetic heating device in accordance with the present invention;

FIG. 18 shows an arrangement of a first embodiment of the centrifugal magnetic heating device in accordance with the present invention;

FIG. 19 shows schematically a second embodiment of the centrifugal magnetic heating device in accordance with the present invention;

FIG. 20 shows schematically a third embodiment of the centrifugal magnetic heating device in accordance with the present invention;

FIG. 21 shows schematically a fourth embodiment of the centrifugal magnetic heating device in accordance with the present invention;

FIG. 22 shows schematically a fifth embodiment of the position resuming member for the centrifugal magnetic heating device in accordance with the present invention; and

FIG. 23 shows schematically a sixth embodiment of the position resuming member for the centrifugal magnetic heating device in accordance with the present invention.

### DESCRIPTION OF THE PREFERRED EMBODIMENT

The invention disclosed herein is directed to a centrifugal magnetic heating device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

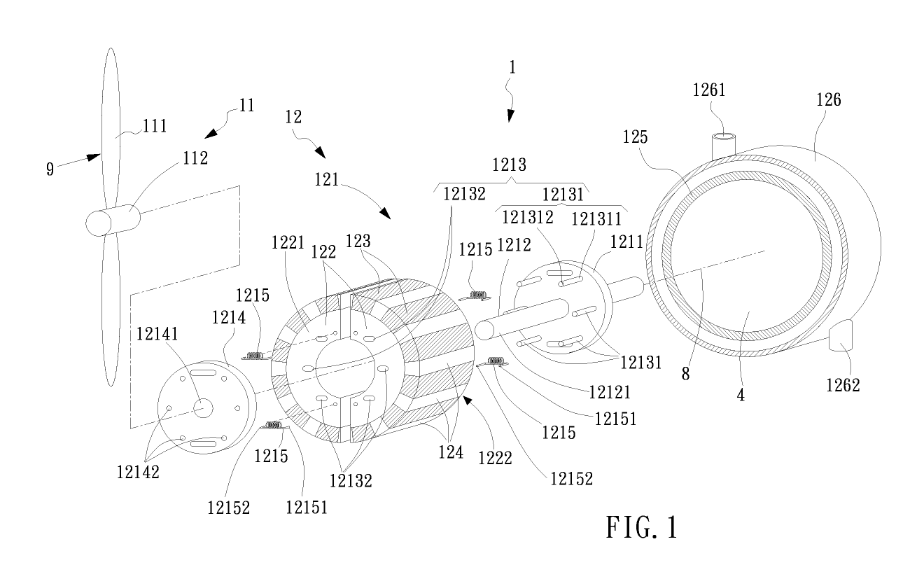

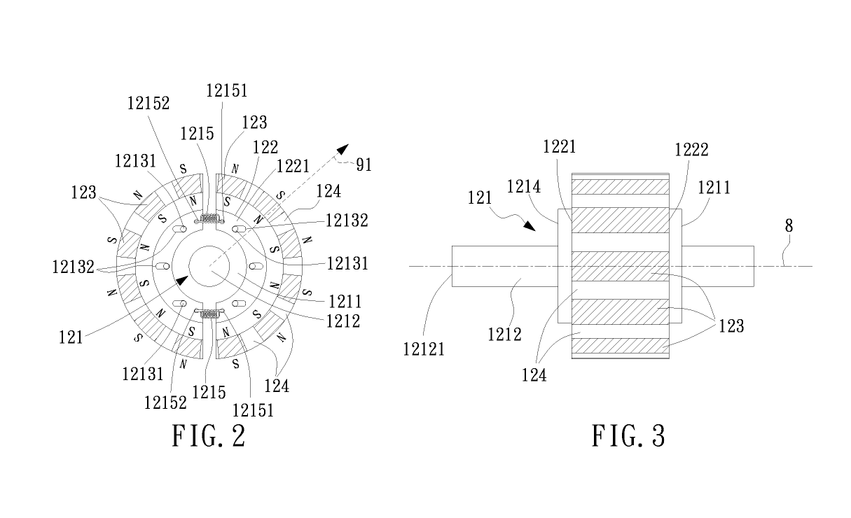

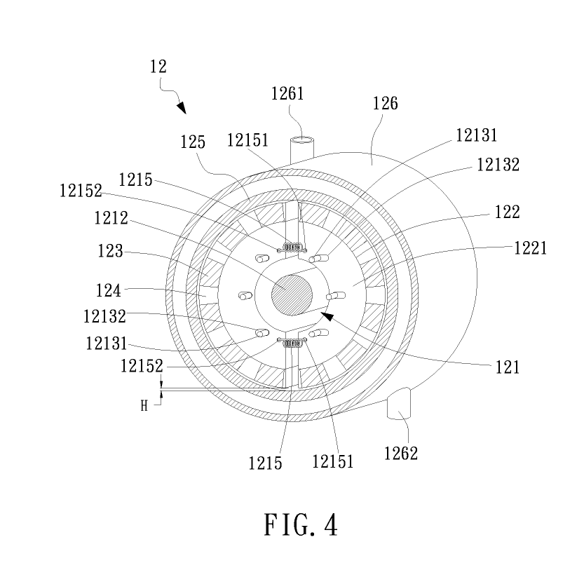

Refer now to FIG. 1, FIG. 2, FIG. 3 and FIG. 4, in which an exploded view of a preferred centrifugal magnetic heating device in accordance with the present invention, a front view of a heat generator for the centrifugal magnetic heating device, a lateral view thereof, and an engagement of the heat generator, the water jacket member and the heat conduction member for the centrifugal magnetic heating device are shown, respectively.

In the present invention, the centrifugal magnetic heating device 1 is mainly to utilize a wind power 9 or a nature flow such as a water flow, a tidal flow or the like as the power source. The centrifugal magnetic heating device 1 of the present invention is defined with a central axis 8 and further includes a power receiving mechanism 11 and a heat generator 12. The power receiving mechanism 11 is mounted on a casing or a frame (not shown herein) above the ground by a predetermined height and further includes a van set 111 and a transmission module 112.

The heat generator 12 further includes a centrifugal mechanism 121, a plurality of bases 122, a plurality of permanent magnets 123, a magnet frame 124, at least a conductive member 125 and a water jacket member 126. As shown, each of the permanent magnets 123 of the heat generator 12 is formed as an arc strip. The permanent magnets 123 are arranged exteriorly to circulate the pillar-shape base 122 so as to form a rotor-shape shaft, and every two neighboring permanent magnets 123 are spaced by respective protrusion ribs of the magnet frame 124. In the art, such an arrangement of the aforesaid rotor structure for generators or motors is called a squirrel cage type of rotors. The centrifugal mechanism 121 is coupled in power with the transmission module 112. The bases 122 mounted on the centrifugal mechanism 121 is to load the plural permanent magnets 123 to react with the conductive member 125 in a central accommodation room 4 encircled by the water jacket member 126 so as to form eddy currents on the conductive member 125. The eddy currents on the conductive member 125 are further to generate heat thereon, and the heat is further conducted to a heat conduction fluid inside the water jacket member 126. In the present invention, the heat conduction fluid can be a liquid or a gas; preferably, a water.

In the present invention, the permanent magnets 123 can be made of a strong magnetic material and are located on the magnet frame 124 in a circular array on the bases 122. The base 122 can be made of a magnetic material such as an iron or a material with better magnetic conductivity. Appropriate arrangement on the base 122 can promote the magnetic conductivity and also can reduce manufacture cost.

In the present invention, the magnet frame 124 protects the permanent magnets 123 from being projected away by the centrifugal force produced by the rotation of the bases 122 driven by the transmission module 112 of the power receiving mechanism 11. Also, the rusting problem in the permanent magnets 123 can be thus be lessened.

In the present invention, the magnet frame 124 can be made of a non-magnetic material, such as aluminum, stainless steel, Bakelite plate, resin or any non-magnetic material the like. While inserting the permanent magnets 123 into the magnet frame 124, a high temperature resistant resin, rubber or any material the like can be filled into the spacing around the permanent magnets 123 so as to anchor fixedly the permanent magnets 123 and also able to obtain advantages in moisture proof and anti-corrosion. As the permanent magnets 123 are settled in the magnet frame 124, the heads of the permanent magnets 123 can be located under, above or flush with the exterior surface of the magnet frame 124.

As shown in FIG. 2, polarities of neighboring permanent magnets 123 mounted inside the magnet frame 123 on the bases 122 are switched over and the alignment of the permanent magnets 123 circling the bases 122 thereon is in a parallel way along the central axis 8. In the present invention, the permanent magnet 123 can be round, trapezoidal, triangular, polygonal, or any irregular-cross sectional cylindrical shape the like.

Namely, the arrangements of the permanent magnets 123 can be various, and each of the permanent magnets 123 has its own polarity (N pole or S pole). In particular, the switching arrangement in polarity for neighboring magnets 123 is the preferred one. As the neighboring magnets 123 to have different polarities, the induced magnetic lines would be inter-looped. By providing the attraction between neighboring magnets 123, the magnetic lines can pass the neighboring magnetic field easier with less magnetic rejection. Thereby, local magnetic resistance can be reduced to a minimum. By compared to the loop of the magnetic lines of the individual permanent magnet 123, the phenomenon of cutting through the high magnetic resistant air can be avoided. It is also noted that the exterior configuration of the permanent magnet 123 is also a factor to the formation of the magnetic lines. It is known that less spacing between neighboring N-pole and S-pole magnets 123 would be preferred. Of course, the aforesaid spacing is definitely a design factor and shall be adjusted according to various operational situations.

As shown in FIG. 1, for the centrifugal magnetic heating device 1 in accordance with the present invention, the permanent magnets 123 are purposely designed to be arc-strip shaped so as to enlarge the total magnetic surface of the permanent magnets 123 to face the conductive member 125 in the accommodation room 4. Such an arrangement of arc-strip magnets 123 is preferable in obtaining larger magnetic fields and better heating performance.

In embodiments of the present invention, the centrifugal mechanism 121 further includes a carrier disc 1211, a transmission shaft 1212, a plurality of positioning modules 1213, a pairing disc 1214, and a plurality of position-resuming members 1215. The transmission shaft 1212 is located centrally to penetrate the carrier disc 1211. One end 12121 of the transmission shaft 1212 is anchored in a central hole 12141 of the pairing disc 1214 for establishing power connection with the transmission module 112 of the power receiving mechanism 11.

In the embodiment of the present invention, the bases 122 are two opposing arc-shaped blocks to hold the transmission shaft 1212 from opposing sides and are mounted by the positioning modules 1213 to locate between the carrier disc 1211 and the pairing disc 1214. In the present invention, the position-resuming member 1215 is structured to be a position-resuming spring, having a first end 12151 and a second end 12152 to be fixed on the respective bases 122 so as to elastically hold the bases 122 along the direction of the transmission shaft 1212, i.e. along the central axial direction 8.

The positioning module 1213 of the centrifugal mechanism 121 further includes a plurality of position pillars 12131 and a plurality of guiding channels 12132 corresponding individually the position pillars 12131, in which each of the guiding channels 12132 is to regulate the motional direction and the displacement of the corresponding position pillar 12131 thereinside. As shown, each of the guiding channels 12132 penetrates the base 122 between two opposing surfaces 1221 and 1222. One end 121311 of the position pillar 12131 is located at the carrier disc 1211, while another end 121312 is to pass the corresponding guiding channel 12132 and to anchor at a corresponding one of a plurality of position holes 12142 on the pairing disc 1214. For the bases 122 is restrained by the positioning module 1213, the bases 122 can be then moved in a limited manner of relative motion between the guiding channels 12132 and the corresponding position pillars 12131, and such the relative motion in the guiding channels 12132 between the bases 122 and the positioning module 1213 can be further regulated resiliently by the position-resuming members 1215 located at proper positions respective to the guiding channels 12132.

In the present invention, the water jacket member 126 wrapped completely by a thermal-proof material includes at least a water outlet 1261 and a water inlet 1262. The heat conduction fluid (a liquid or a gas) inside the water jacket member 126 can flow through the water outlet 1261 or/and the water inlet 1262 so as to perform heat exchanging or direct heating upon the heat conduction fluid. The water jacket member 126 can be embodied as a cylindrical water jacket member having internal spiral guiding structures so as to lead the heat conduction fluid to flow in the water jacket member 126 via the water inlet 1262, then to flow through the internal spiral guiding structures for experiencing sufficient heat exchange, and finally to flow out of the water jacket member 126 via the water outlet 1261.

The power receiving mechanism 11 is dynamically coupling with the heat generator 12 via the transmission module 112, in a manner of spacing, by an H, the permanent magnets 123 mounted on the magnet frame 124 of the bases 122 pivotally engaged with the centrifugal mechanism 121 and the conductive member 125 on the water jacket member 126. Through the vane set 111 to rotate the transmission module 112, the wind power 9 can drive the centrifugal mechanism 121 so as to automatically control the spacing H between the permanent magnets 123 and the conduction member 123 and thereby to achieve the object of rapid heat generation.

Through a proper design of the vane set 111 in shaping, structuring and/or arranging, the wind power 9 or the like nature flow can drive the power receiving mechanism 11 and further the centrifugal mechanism 121, the centrifugal force 91 induced from rotating the centrifugal mechanism 111 can energize the position-resuming member 1215 so as to further vary the spacing H between the permanent magnets 123 and the conductive member 125. Particularly, while the rotation speed of the centrifugal mechanism 121 goes high as the wind power 9 increases, the centrifugal force 91 goes also higher to reduce the spacing H between the permanent magnets 123 and the conductive member 125; such that heat generation efficiency can be increased. On the other hand, while the rotation speed of the centrifugal mechanism 121 goes low as the wind power 9 decreases, the resilient force provided by the position-resuming springs can present to make larger the spacing H between the permanent magnets 123 and the conductive member 125; such that magnetic effect is reduced so as to enable the low-spin centrifugal mechanism 121 to keep heat generation.

In the present invention, the wind power 9 drives the vane set 111, the vane set 111 rotates the permanent magnet 123 on the bases 122 of the centrifugal mechanism 121 so as to change the spacing H between the permanent magnets 123 and the conductive member 125 and also to vary the magnetic lines as well as the magnetic field. When the magnetic field passing the conductive member 125 induces an eddy current respective to the permanent magnets 123, the eddy current can flow on the conductive member 125 and to generate heat for further heating the fluid inside the water jacket member 126.

In the basic electricity theory, it is well known that the power is proportional to the square of the current. Also, the smaller the electric resistance coefficient of the electric conductive member 125 is, the easier the electric conduction can be, the more thermal energy can be produced, and the larger rotational resistance the power receiving mechanism 11 needs to encounter. Namely, in the present invention, the material for the electric conductive member 125 of the heat generator 12 must be an excellent electric conduction material, such as a gold, silver, copper, iron, aluminum, or alloy of any combination of the foregoing metals. In one embodiment of the present invention, the electric conductive member 125 is preferably made of a pure aluminum for its excellent properties in non-magnets, electric conduction, thermal conduction, and less costing by compared to the gold and silver. With such a material choice in the electric conductive member 125, the heat generated in the electric conductive member 125 can be rapidly conducted to the heat conduction medium inside the water jacket member 126. In the present invention, the magnetic force of the permanent magnet 123 is also one of factors for forming the eddy current. Theoretically, according to the Lenz law, the larger the magnetic field, the more eddy currents can then be produced.

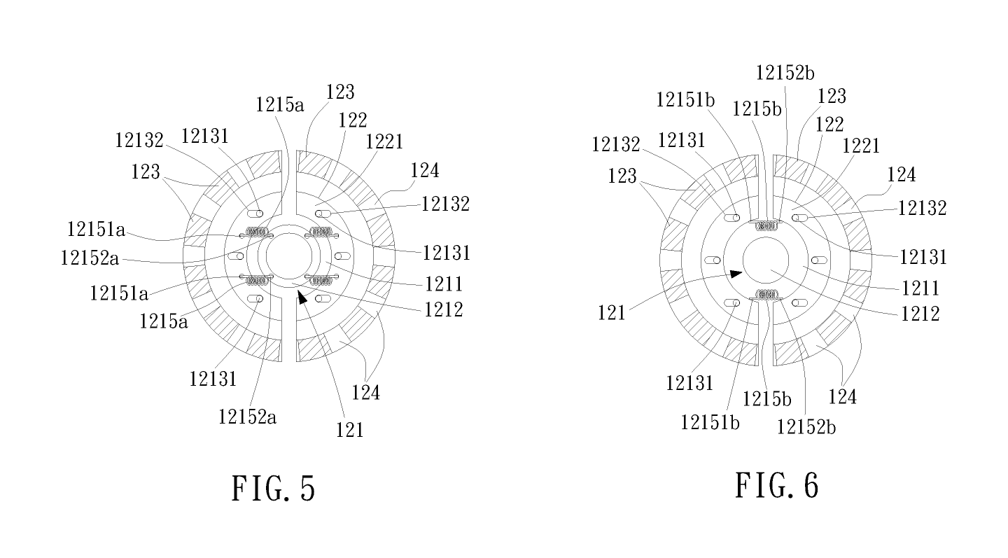

Referring now to FIGS. 5-8, a first, second, third and fourth embodiments of position-resuming member for the centrifugal magnetic heating device in accordance with the present invention are schematically shown, respectively.

As shown in FIG. 5, the position-resuming member 1215a is formed as a position-resuming spring, having one end 12151a (the first end) fixed to the corresponding base 122 and another end 12152a (the second end) fixed to the transmission module 1212. The position-resuming member 1215a is to perform an elastic engagement by elastically pulling the respective base 122 along the direction towarding the transmission shaft 1212 (i.e. the central axial direction 8).

As shown in FIG. 6, the position-resuming member 1215b is also formed as a position-resuming spring, having the first end 12151b and the second end 12152b fixed to the respective bases 122. By providing the position-resuming members 1215b, each of the bases 122 is pulled elastically inward and toward the center of the device, i.e. by elastically depressing the bases 1215b onto the transmission shaft 1212 along the radial direction towarding the transmission shaft 1212 (i.e. the central axial direction 8).

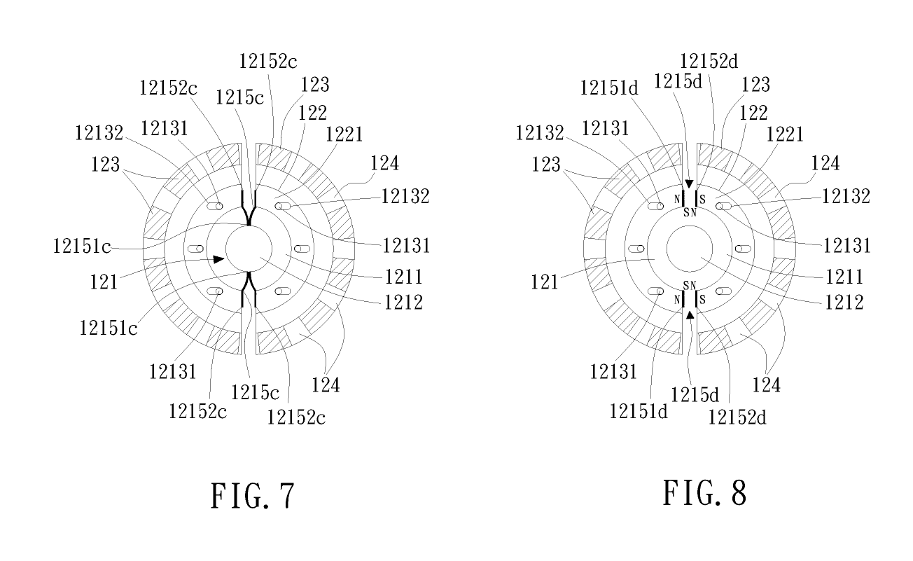

As shown in FIG. 7, the position-resuming member 1215c is formed as a V-shape or Ω-shape spring plate, having a central tip 1215c anchored to the transmission shaft 1212. Two opposing free ends 12152c of the spring plate 1215c are fixed respectively to the different neighboring bases 122. By providing elasticity and stiffness of the spring plate 1215c, the bases 122 are pushed elastically to contact solidly onto the transmission shaft 1212 along the direction towarding the transmission shaft 1212 (i.e. the central axial direction 8).

As shown in FIG. 8, the position-resuming member 1215d is formed as a magnetic guiding structure. By providing magnetic attraction of the magnetic guiding structure 1215d, the bases 122 can be elastically depressed onto the transmission shaft 1212 along the direction towarding the transmission shaft 1212 (i.e. the central axial direction 8). In this embodiment, the magnetic guiding structure 1215d can be formed as one of the following.

1. Locate at least one permanent magnet 12151d or 12152d to each of the neighboring bases 122 with the same or different magnetic poles (N poles or S poles).

2. Locate corresponding permanent magnets 12151d or 12152d to the adjacent ends of the neighboring bases 122 with the same or different magnetic poles (N poles or S poles), while at the other ends of the bases 122 magnetic blocks are mounted to ensure the motional direction defined by the magnetic attraction.

3. Have the base 122 made of a magnetic material and have the neighboring bases to have different magnetic polarity.

In the aforesaid arrangement of the magnetic polarity for the bases 122, it is noted that neighboring bases 122 are arranged to have different magnetic poles so as to obtain attraction in between. The attraction is also combined to exert a depression for the bases 122 to elastically contact the central transmission shaft 1212. For related resorts are all conventional practices in magnetic theories, details thereabout are thus omitted herein.

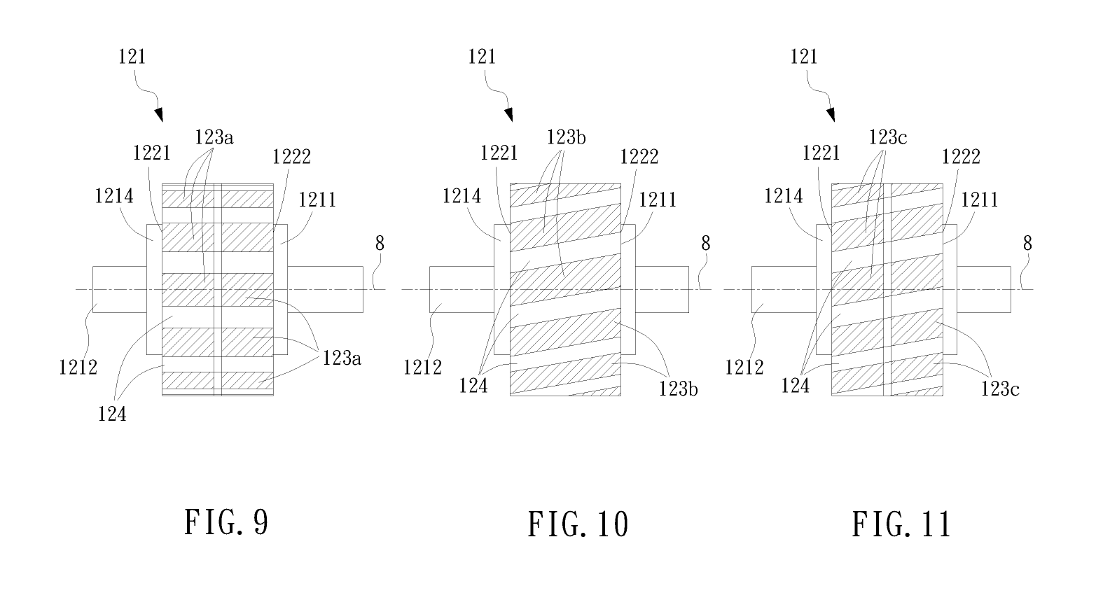

Referring now to FIG. 9, FIG. 10 and FIG. 11, a first, a second and a third embodiment of arrangements of the permanent magnets for the centrifugal magnetic heating device in accordance with the present invention are shown, respectively. In the present invention, the arrangement of the permanent magnets 123 on the bases 122 can be an arrangement of having plural sets (two shown in FIG. 9) of permanent magnets 123a to surround exteriorly the bases 122 along the center axial direction 8 in a symmetric, horizontal and parallel manner (as shown in FIG. 9), an arrangement of having a helix set of the permanent magnets 123b to surround exteriorly the bases 122 along the center axial direction 8 in a twist manner by compared to FIG. 9 (as shown in FIG. 10), or an arrangement of having plural sets (two shown in FIG. 11) to surround exteriorly the bases 122 along the center axial direction 8 in an asymmetric and helix manner like FIG. 10 (as shown in FIG. 11).

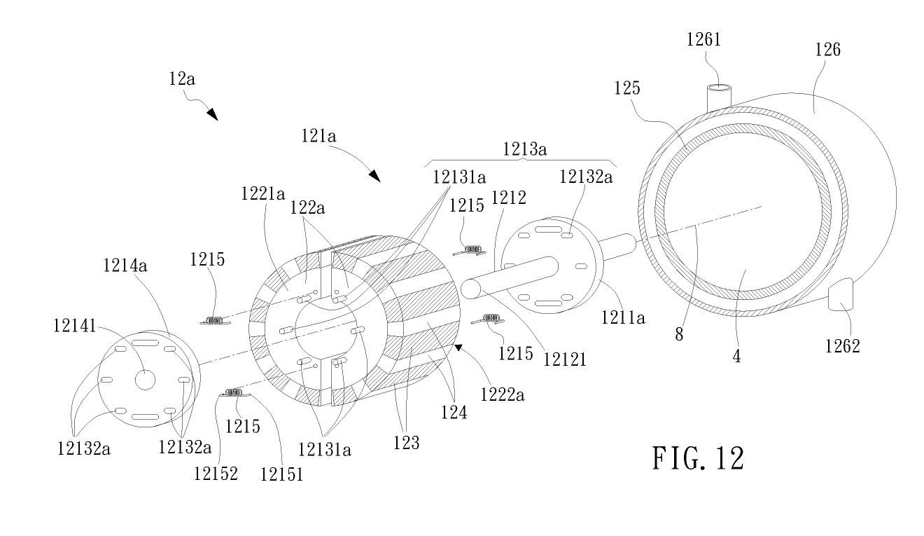

Referring now to FIG. 12, an exploded view of a first embodiment of the heat generator of the centrifugal magnetic heating device in accordance with the present invention is shown. By comparing the heat generator of FIG. 12 with that of FIG. 1, it is noted that major elements are the same for these two embodiments. Therefore, for sake of concise description, the same elements and structures are omitted herein. Yet, the major difference between this embodiment and that of FIG. 1 is at the positioning module for the centrifugal mechanism. In this first embodiment of the heat generator 12a, each of the positioning pillars 12131a of the positioning module 1213a has its opposing ends located to respective opposing end surfaces 1221a and 1222a of the base 122a, and the guiding channels 12132a are located on either the carrier disc 1211a or the pairing disc 1214a, at positions respective to the positioning pillars 12131a. In this embodiment, position pairing of the positioning module 1213a is formed by the positioning pillars 12131a on the end surfaces 1221a, 1222a of the bases 122a and the guiding channels 12132a on the carrier disc 1211a and the pairing disc 1214a.

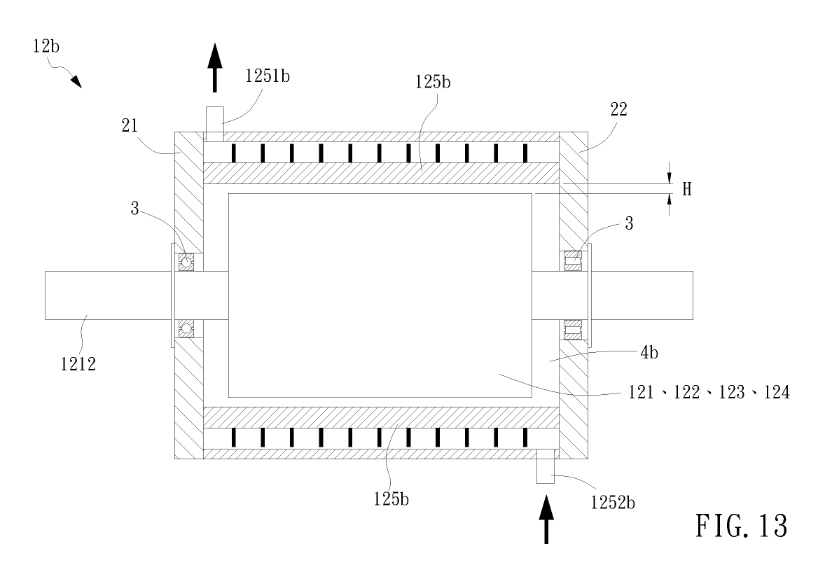

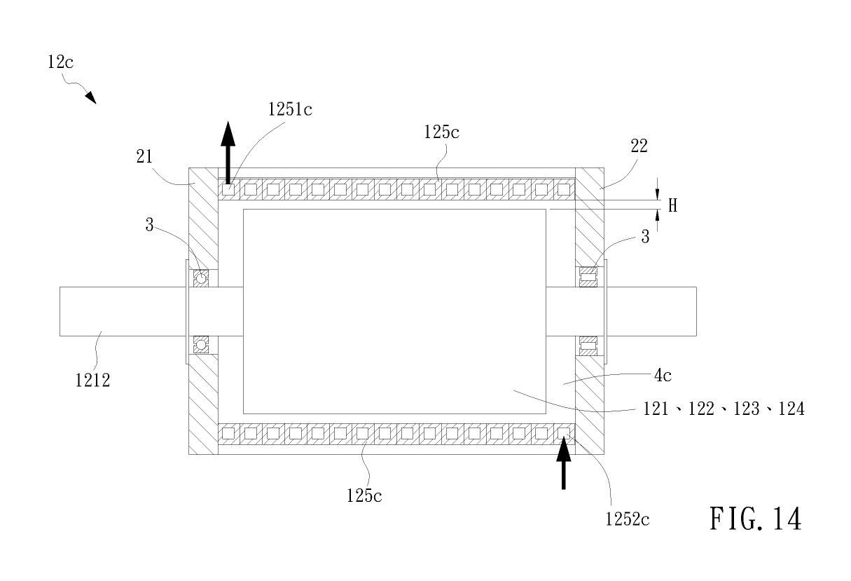

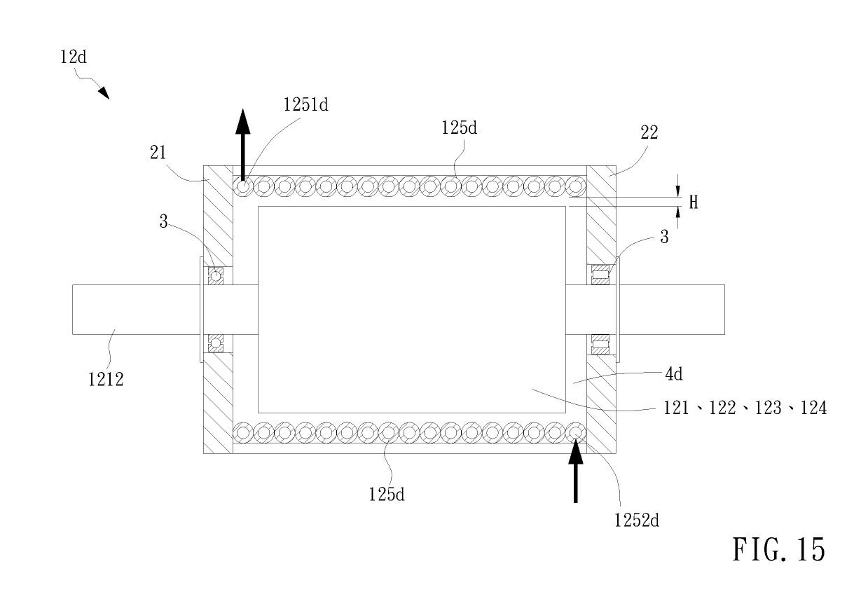

Referring to FIG. 13, FIG. 14 and FIG. 15, cross-sectional views of a first, a second and a third embodiment of the conductive member for the heat generator of the centrifugal magnetic heating device in accordance with the present invention are shown, respectively. The conductive member 125b, 125c, 125d for the heat generator 12b, 12c, 12d in the first, the second and the third embodiment can be any one of the following structures: one 125b that has a laminar-plate or spiral-fin interior, one 125c that has a rectangular circulating piping, or one 125d that has round circulating piping. Further, in these three embodiments of the conductive member 125b, 125c, 125d, the aforesaid interior structures can be used to directly guide flows of the heat conduction fluid, the same heat conduction fluid that flows in the water jacket member 126 of FIG. 1 or FIG. 12. Upon such an arrangement, the heating of the heat conduction fluid can be performed directly inside the conductive member 125b, 125c or 125d.

As shown, an upper cover 21 and a lower cover 22 can be introduced to complete the structuring of the conductive member 125b, 125c, 125d for the heat generator 12b, 12c, 12d in the first, the second and the third embodiment. With the upper cover 21 and the lower cover 22 to fix and seal from both sides of the conductive member 125b, 125c, 125d for the heat generator 12b, 12c, 12d in the first, the second and the third embodiment, with the transmission shaft 1212 to penetrate the conductive member 125b, 125c, 125d and respective bearings 3 at the upper cover 21 and the lower cover 22, and with the combo of the bases 122, the magnet frame 124 and the permanent magnets 123 to be installed and rotated thereafter inside an accommodation room 4b, 4c, 4d formed by the upper cover 21, the conductive member 125b, 125c, 125d and the lower cover 22, the permanent magnets 123 inside the accommodation room 4b, 4c, 4d can then rotate to react with the conductive member 125b, 125c, 125d so as to induce eddy currents for heating up the conductive member 125b, 125c, 125d for the heat generator 12b, 12c, 12d in the first, the second and the third embodiment. The generated heat is then stored into the heat conduction fluid flowing inside the conductive member 125b, 125c, 125d. In the present invention, the conductive member 125b, 125c, 125d can be made of a material selected from the group including a copper, an aluminum, an iron, and any proper alloy.

As shown in FIG. 13, the interior structure of the conductive member 125b includes laminar plates or spiral fins. The spiral fins are to guide the internal flow of the heat conduction fluid circulating inside the conductive member 125b. The conductive member 125b is to wrap thereinside the permanent magnets 123 by a predetermined spacing H. The conductive member 125b further includes a water-out going hole 1251b and a water-in coming hole 1252b for allowing the heat conduction fluid to flow out and flow in the conductive member 125b, respectively, for performing another possible exterior heat exchanging.

As shown in FIG. 14, the conductive member 125c has an interior structure of rectangular circulating piping; i.e. the circulating piping with the cross section of the hollow pipe formed as a hollow rectangular shape. The piping is to circulate exteriorly the permanent magnets 123 by a predetermined spacing H. The conductive member 125c further includes a water-out going hole 1251c and a water-in coming hole 1252c for allowing the heat conduction fluid to flow out and flow in the conductive member 125c, respectively, for performing another possible exterior heat exchanging.

As shown in FIG. 15, the conductive member 125d has an interior structure of round circulating piping; i.e. the circulating piping with the cross section of the hollow pipe formed as a hollow round shape. The piping is to circulate exteriorly the permanent magnets 123 by a predetermined spacing H. The conductive member 125d further includes a water-out going hole 1251d and a water-in coming hole 1252d for allowing the heat conduction fluid to flow out and flow in the conductive member 125d, respectively, for performing another possible exterior heat exchanging.

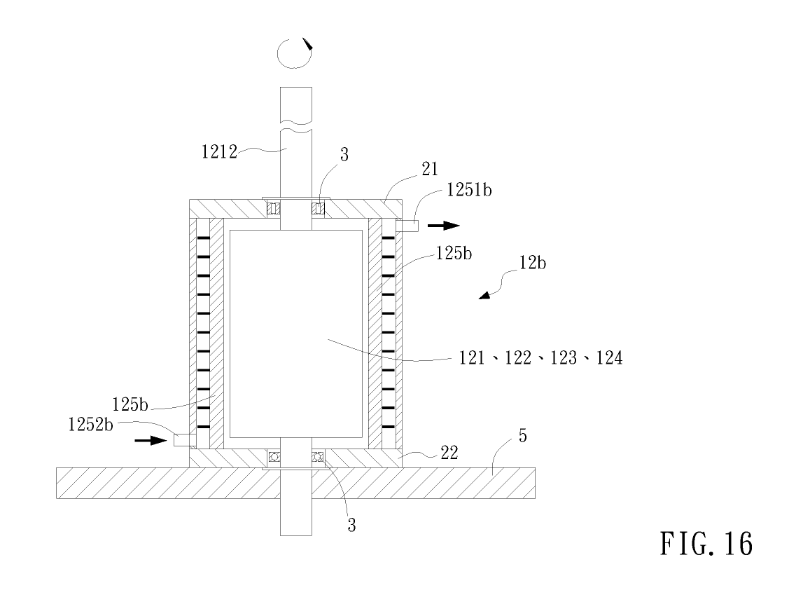

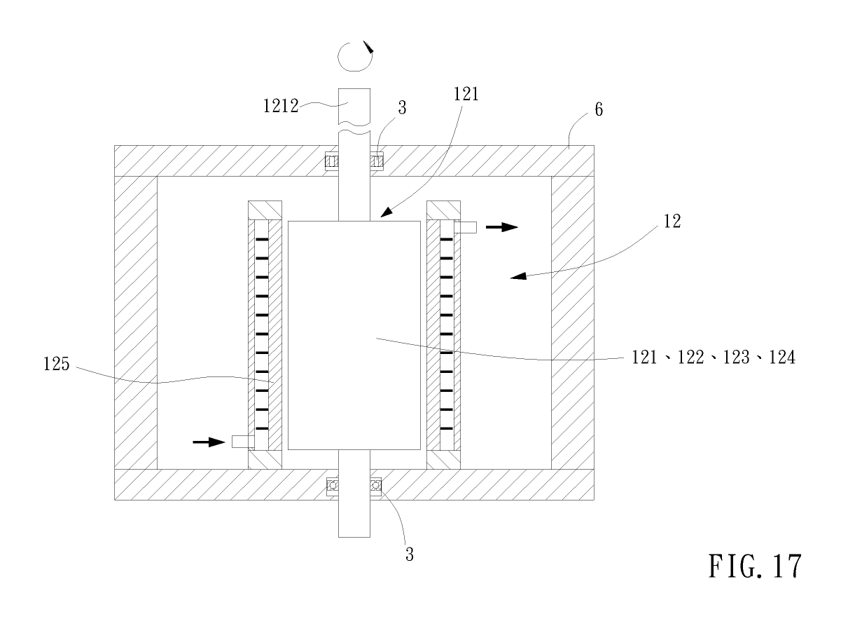

Referring now to FIG. 16 and FIG. 17, cross-sectional views of a first and a second embodiment of the heat generator for the centrifugal magnetic heating device in accordance with the present invention are shown, respectively. The heat generator 12 for the centrifugal magnetic heating device 1 in accordance with the present invention can be installed on a platform 5 as shown in FIG. 16, while the heat generator 12 can be any of FIG. 13, FIG. 14 and FIG. 15. As illustrated in FIG. 16, the heat generator 12 is the same as that shown in FIG. 13.

Furthermore, as shown in FIG. 17, the heat generator 12 can be installed into a housing or a frame 6. The transmission shaft 1212 of the centrifugal mechanism 121 is hold in between by a pair of bearings 3 on the housing 6, one located above the heat generator 12 and another located below the heat generator 125. The heat generator 12 can be any of FIG. 13, FIG. 14 and FIG. 15. In particular, with the conductive member 125 to be mounted fixedly inside the housing 6, the heat generator 12 can be further protected thereby.

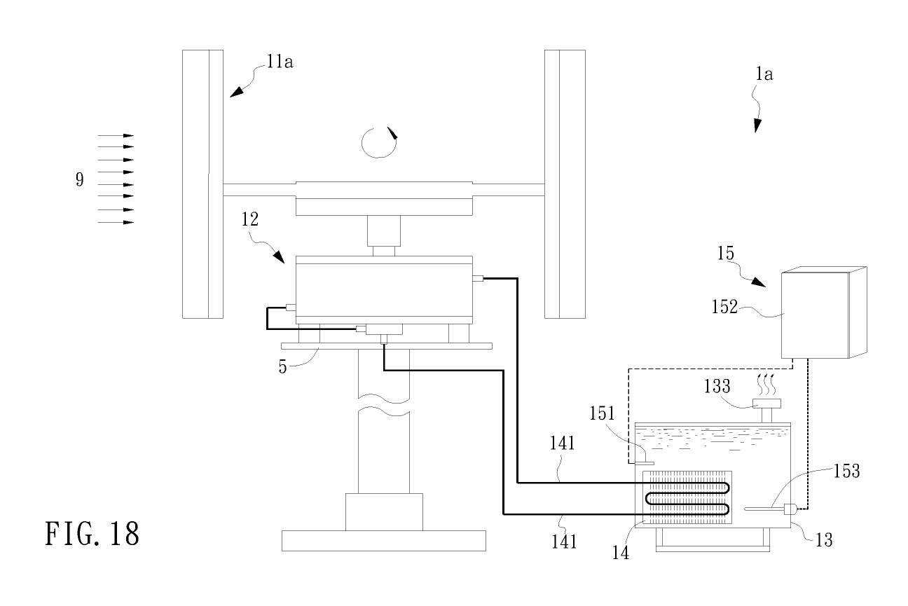

Referring now to FIG. 18, an arrangement of a first embodiment of the centrifugal magnetic heating device in accordance with the present invention is schematically shown. As illustrated, the first embodiment 1a of the centrifugal magnetic heating device is formed to have a vertical-shaft power receiving mechanism 11a, and the power receiving mechanism 11a is mounted fixedly on a platform 5 and is to engage the heat generator 12 installed on the platform 5. The centrifugal magnetic heating device 1 further includes a heat storing apparatus 13, a heat conduction member 14 and an auxiliary heating device 15.

The heat storing apparatus 13 includes thereinside a heat conduction medium and has an exhaust pipe 133 for pressure balancing. The heat conductive member 14 mounted inside the heat storing apparatus 13 can transfer the heat generated in the heat generator 12 to the heat storing apparatus 13 via the conductive member 14. In this embodiment, the heat conductive member 14 mainly includes a heat dissipation manifold 141 having a plurality of external heat-dissipating fins. Two ends of the heat dissipation manifold 141 of the heat conductive member 14 are in fluid communication with the heat generator 12 so as to establish internal heat circulation in between.

The auxiliary heating device 15 further includes a temperature detector 151, a controller 152 and a heater 153. Both the temperature detector 151 and the heater 153 are mounted on the heat storing apparatus 13 and are electrically coupled with the controller 152. The temperature detector 151 is to detect if the temperature inside the heat storing apparatus 13 is low enough to activate the controller 152 to further process a heating procedure of the heater 153 upon the heat storing apparatus 13.

In the first embodiment of the centrifugal magnetic heating device in accordance with the present invention 1a, the heat generator 12 can also adopt any of the designs shown in FIG. 1(12), FIG. 12(12a), FIG. 13(12b), FIG. 14(12c) and FIG. 15(12d).

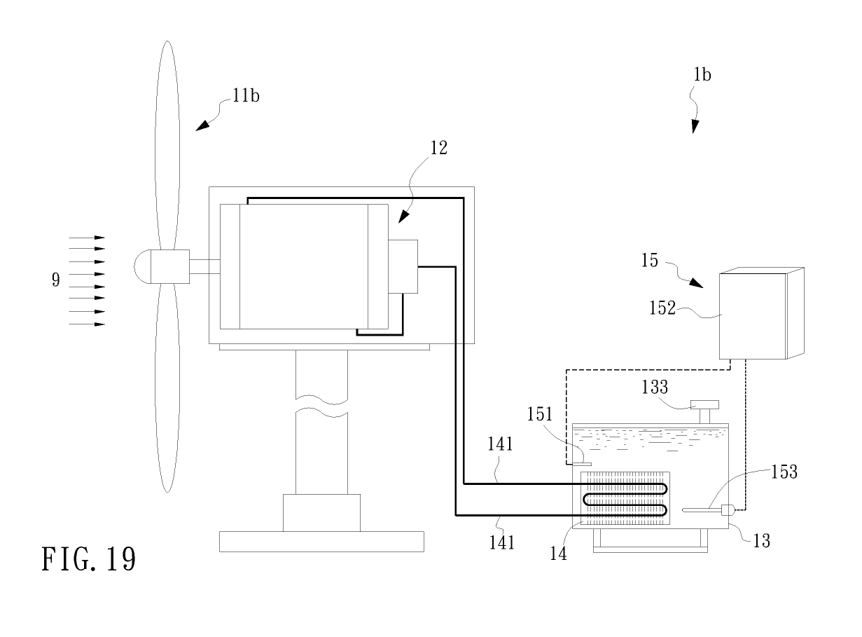

Referring now to FIG. 19, a second embodiment of the centrifugal magnetic heating device in accordance with the present invention is shown. It is noted that the major difference between this embodiment and that shown in FIG. 18 is that the power receiving mechanism 11b of this embodiment 1b is a horizontal-shafting type.

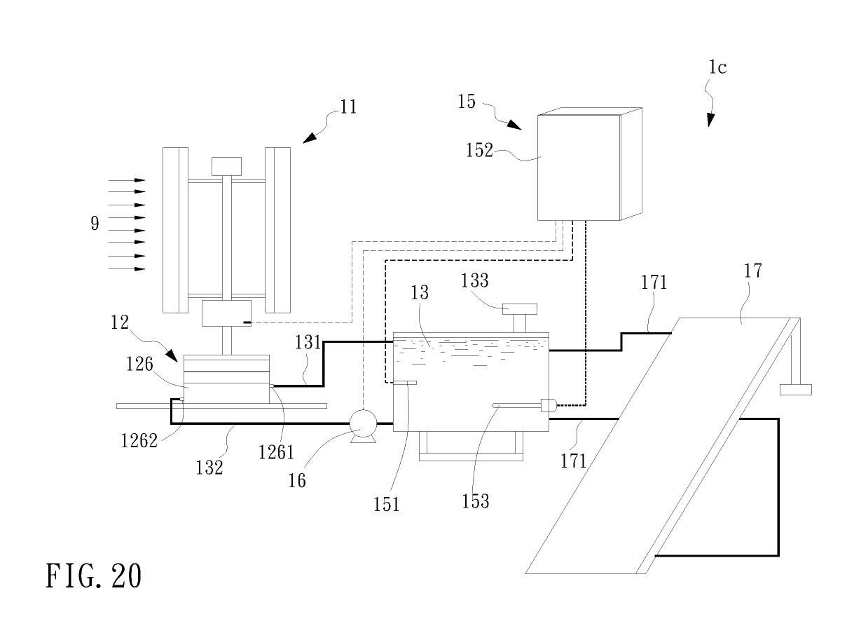

Referring now to FIG. 20, a third embodiment of the centrifugal magnetic heating device in accordance with the present invention is shown. It is noted that the major difference between this embodiment and that shown in FIG. 18 is that in this embodiment 1b the heat storing apparatus 13 and the heat generator 12 are directly connected in a fluid communication manner. In this arrangement, an input junction 131 and an output junction 132 are introduced to connect the heat storing apparatus 13 and the water jacket member 126 at the water outlet 1261 and the water inlet 1262, respectively; so as to establish the internal circulation of a common heat conduction medium.

In addition, the third embodiment of the centrifugal magnetic heating device 1c in accordance with the present invention can further include an auxiliary circulation device 16 and a solar water heater 17. The auxiliary circulation device 16 for promoting the circulation of the heat conduction medium between the water jacket member 126 and the heat storing apparatus 13 can be a wind pump or an electric pump located at a predetermined position at the output junction 132 of the heat storing apparatus 13. The solar water heater 17 can have two internal piping 171 to form a fluid-communication connection with the heat storing apparatus 13. In this embodiment, in the case that the auxiliary circulation device is a wind pump, the wind pump can be directly driven by the heat generator 12. In another embodiment, the wind pump might have its own power source; for example, an independent vane set.

In the third embodiment of the centrifugal magnetic heating device in accordance with the present invention 1c, the heat generator 12 can adopt any of the designs shown in FIG. 1(12) and FIG. 12(12a). An internal close loop heat conduction/convection circulation of the heat conduction medium between the water jacket member 126 and the heat storing apparatus 13 can be established by connecting the water outlet 1261 and water inlet 1262 of the water jacket member 126 to the input piping 131 and the output piping 132 of the heat storing apparatus 13, respectively.

In the third embodiment of the centrifugal magnetic heating device in accordance with the present invention 1c, the heat generator 12 can also adopt any of the designs shown in FIG. 13(12b), FIG. 14(12c) and FIG. 15(12d). By connecting the water-out going hole 1251b, 1251c, 1251d and the water-in going hole 1252b, 1252c, 1252d of the conductive member 125b, 125c, 125d to the input piping 131 and the output piping 132 of the heat storing apparatus 13, an internal heat circulation between the conductive member 125b, 125c, 125d and the heat storing apparatus 1c can thus be successfully constructed.

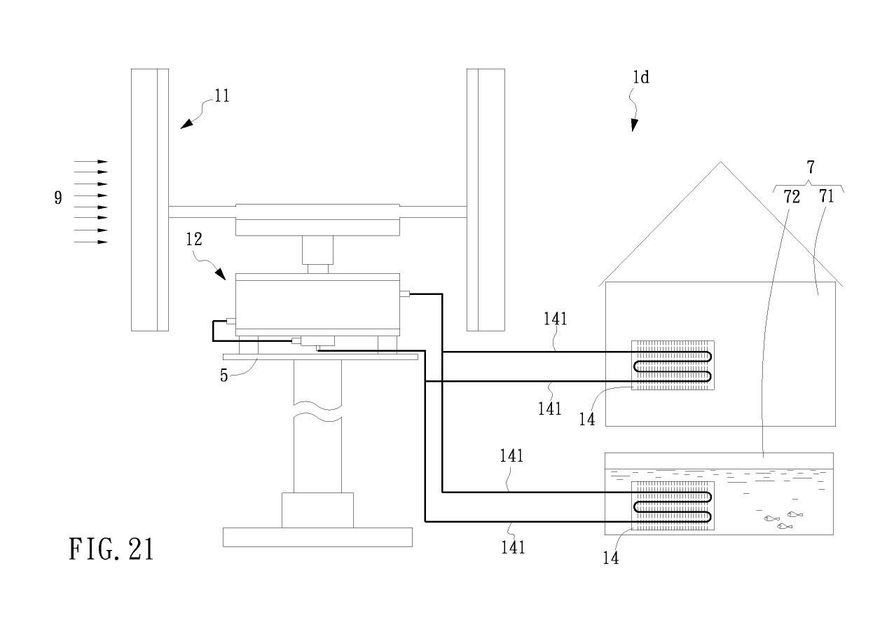

Referring now to FIG. 21, a fourth embodiment of the centrifugal magnetic heating device in accordance with the present invention 1d is shown. In this embodiment, the conductive member 14 is used to directly heat up a plurality of to-be-heated districts 7. The to-be-heated district 7 can be a building 71 or a water tank 72. These to-be-heated districts 7 can utilize corresponding conductive members 14 and various forms of the heat-dissipating manifolds 141 to forward the heat generated by the heat generator 12 to the building 71 or the water tank 72. Upon such an arrangement, the heat generator 12 powered by the power receiving mechanism 11 can be versatile for different heating applications; for example, to condition the room temperature of the building 71 or to purposely keep warm of the water tank 72 for further breeding creatures such as fishes. Of course, the to-be-heated districts 7 cannot be deemed to be limited to the aforesaid applications, some other applications such as heat sinks, swimming pool and so on can still prevail, according to the present invention.

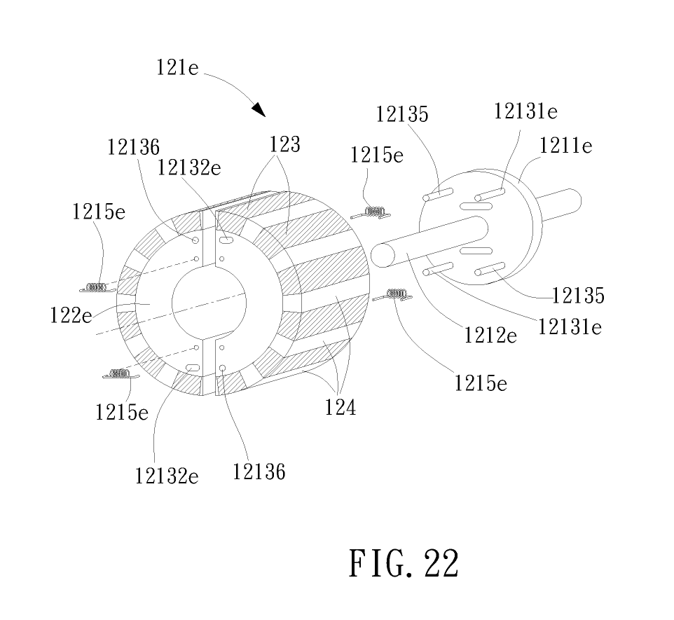

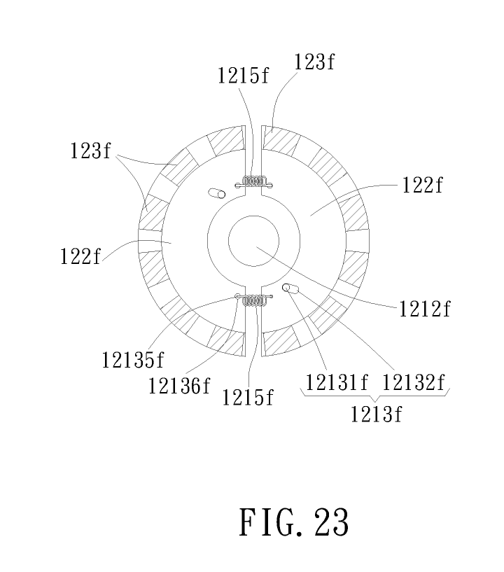

Referring now to FIG. 22, a fifth embodiment of the position resuming member 1215e and the accompanying bases 122e for the centrifugal magnetic heating device in accordance with the present invention is schematically shown. In this embodiment, the same power receiving mechanism and the same heat generator as those in the first embodiment of FIG. 1 are included. In particularly, the power receiving mechanism can similarly include a vane set and a transmission module, while the heat generator can also include a centrifugal mechanism, a plurality of bases, a plurality of permanent magnets, a magnet frame, at least a conductive member, and a water jacket member. It is noted that, for the only difference between this embodiment and that of FIG. 1 is the pairing of the bases 122e and the plural position resuming members 1215e, details nor related to this pairing in this embodiment will be omitted herein.

As shown in FIG. 22, each of the two bases 122e (centrifugal blocks) formed as a semi-circular pair includes a guiding channel 12132e connecting the front and the rear surfaces of the corresponding base 122e in a penetration way, a pivotal hole 12136, and two engagement holes (not labeled in the figure) for the position resuming members. The location of the pivotal hole 12136 of one base 122e is right next to the guiding channel 12132e of the other base 122e. Both ends of the position resuming member 1215e are fixed to the respective engagement holes at different bases 122e so as to provide resilient forcing for pulling close the pair of the two bases 122e. Namely, the position resuming members 1215e provide each of the bases 122e the forcing for elastically contacting along the direction towarding the transmission shaft 1212e.

Further, the transmission shaft 1212e is provided to penetrate the carrier disc 1211e in a perpendicular way. Also, on the carrier disc 1211e, two position pillars 12131e and two pivotal pillars 12135 are vertically mounted at the surface of the carrier disc 1211e facing the bases 122e. The transmission shaft 1212e is to form the rotation shaft by being sent through the central hollow hole formed by the pairing of the two bases 122e. Each of the position pillars 12131e is to penetrate the corresponding guiding channel 12132e of the respective base 122e, and each of the pivotal pillars 12135 is to penetrate the corresponding pivotal hole 12136 of the respective base 122e. Upon such an arrangement, the positioning module can thus be established. In the present invention, the dimension of the pivotal hole 12136 is determined by pairing to the dimension of the pivotal pillar 12135, and the width of the guiding channel 12132e is larger than the outer diameter of the position pillar 12135. Thereby, when the transmission shaft 1212e rotates to drive the carrier disc 1211e and the two bases 122e, each base 122 would be affected by the induced centrifugal forcing to swing away about the respective pivotal pair formed by the pivotal pillar 12135 and the pivotal hole 12136. In the case that the rotation speed is increased, the two bases 122e as well as the plural permanent magnets 123 thereon would move close to the conductive member 125. In the present invention, the shape of the guiding channel 12132e in the width direction would act as the range control for swinging the bases 122e. With the guiding channel 12132e to limit the swing of the bases 122e between a wing-out position and a wing-in position, the spacing H between the permanent magnets 123 and the conductive member 125 can be controlled. In addition, while in rotation, the position pillar 12131e in the other guiding channel 12132e of the base 122e would slide along the width direction of the guiding channel 12131e so as to pull the position resuming member 1215e and thus to generate a resilient position resuming contraction force.

Referring now to FIG. 23, a sixth embodiment of the position resuming member 1215f and the bases 122f for the centrifugal magnetic heating device in accordance with the present invention is schematically shown. For most elements of this embodiment are resembled to those of the fifth embodiment of FIG. 22, only the difference in between is elucidated in the following description. As shown in FIG. 23, each of the two semi-ring bases 122f (the centrifugal blocks) includes a guiding channel 12132f, a pivotal hole 12136f and two engagement holes (not labeled in the figure) for the position resuming members. Permanent magnets 123f are located exteriorly to the outer surface of the base 122f. The transmission shaft 1212f penetrates the two bases 122s to act as the rotation shaft. The two position pillars 12131f are to penetrate the respective guiding channels 12132f of the bases 122f, and the two pivotal pillar 12135f are to penetrate the respective pivotal holes 12136f of the bases 122f. Upon such an arrangement, the positioning module 1213f is thus formed. In this embodiment, each of the pivotal holes 12136f does also act as an element resembling to the aforesaid engagement hole for the position resuming members. Namely, an end of the position resuming member 1215f is to engage in the pivotal hole 12136f. Hence, when the transmission shaft 1212f rotates to drive the carrier disc and the two bases 122f, each base 122f would be affected by the induced centrifugal forcing to swing away about the respective pivotal pair formed by the pivotal pillar 12135f and the pivotal hole 12136f. At the same time in rotation, the position pillar 12131f in the guiding channel 12132f of the base 122f would slide along the width direction of the guiding channel 12131f so as to pull the position resuming member 1215f and thus to generate a resilient position resuming contraction force.

By providing the present invention, the centrifugal magnetic heating device 1 can include a power receiving mechanism 11 and a heat generator 12. The power receiving mechanism 11 further includes a vane set 111 and a transmission module 112. The heat generator 12 connected with the transmission module 112 further includes a centrifugal mechanism 121, a plurality of bases 122, a plurality of magnets 123, a magnet frame 124, at least one conductive member 125, and a water jacket member 126. The vane set 111 is driven by a wind power 9 to further drive the heat generator 12 via the transmission module 112 so as to rotate the permanent magnets 123 mounted by the magnet frame 124 on the bases 122. Through the centrifugal mechanism 121 to vary the spacing between the permanent magnets and the conductive member 125 fixed on the water jacket member 126, the electromagnetic field in between can be automatically adjusted. When the magnetic field passes the conductive member 125, an eddy current would be induced thereon, and the eddy current would lead a generation of heat at the conductive member 125. The heat is carried by a fluid inside the water jacket member 126 and to be stored in the heat storing apparatus 13 or to be further applied to plural to-be-heated districts 7.

In the present invention, the combination of the power receiving mechanism 11 and the heat generator 12 for the centrifugal magnetic heating device in accordance with the present invention is preferably to be a vertical-shaft type, in consideration of assembling difficulty. However, the skill person in the art shall understand that any other type of combinations who can drive the heat generator 12 to produce heat, such as a horizontal-shaft type, is also relevant to be applied to the present invention. It is obvious that the power type having higher capacity and higher operational speed is much preferred.

In the present invention, by providing the wind power 9 to rotate the power receiving mechanism 11 and to formulate a centrifugal force 91 to control the spacing between the magnets 123 and the conductive member 125, the heat generator 12 can produce heat from magnetic changes. The design is simple-structured, low-cost and endurable. Further, form the present invention does not require additional electricity, no electric hazards is possible. Also, for no electric generator is needed in the present invention, the dangers in overloading the coil and possible electric fires in the electric modules can thus be avoided.

Also, by providing the centrifugal magnetic heating device of the present invention, while in the windy autumn and winter, more wind power can be available 24 hours a day for producing thermal energy. Therefore, convenient thermal energy as well as the hot water can be available the whole day as long as there is a wind. According to the present invention, various auxiliary devices can be accompanied so as to meet different needs in home, agricultural, commercial, or industrial usages.

While the present invention has been particularly shown and described with reference to a preferred embodiment, it will be understood by those skilled in the art that various changes in form and detail may be without departing from the spirit and scope of the present invention.

What is claimed is:

1. A centrifugal magnetic heating device, defined with an central axis, comprising:
a power receiving mechanism, further including a vane set and a transmission module, the vane set being driven by nature flows to further drive the transmission module to rotate; and
a heat generator, connected with the transmission module, further including a centrifugal mechanism connected to the transmission module, a plurality of bases furnished on the centrifugal mechanism, a plurality of permanent magnets furnished on the bases individually, and at least one conductive member corresponding in positions to the permanent magnets;
wherein the vane set drives the transmission module and further rotates the permanent magnets on the centrifugal mechanism about the conductive member so as to have the conductive member to generate a heat.

2. The centrifugal magnetic heating device according to claim 1, further including a water jacket member fixed with the conductive member, the water jacket member having a water outlet and a water inlet, the heat generated by the conductive member being used to heat up a fluid inside the water jacket member, the fluid performing heat exchanging via flowing through the water outlet and the water inlet, wherein the water jacket member is formed as a cylindrical water jacket member having internal spiral guiding.

3. The centrifugal magnetic heating device according to claim 1, wherein said centrifugal mechanism further includes a carrier disc, a transmission shaft, a plurality of positioning modules, a pairing disc, and a plurality of position-resuming members, the transmission shaft being located centrally to penetrate the carrier disc, one end of the transmission shaft being anchored in a central hole of the pairing disc for establishing power connection with the transmission module of the power receiving mechanism, the bases circulating the transmission shaft and mounted by the positioning modules to locate between the carrier disc and the pairing disc, the position-resuming members being structured to elastically hold the bases along a direction of the transmission shaft.

4. The centrifugal magnetic heating device according to claim 3, wherein said positioning module further includes a plurality of position pillars and a plurality of guiding channels corresponding individually the position pillars, each of the guiding channels being to regulate a motional direction and a displacement of the corresponding position pillar located thereinside.

5. The centrifugal magnetic heating device according to claim 4, wherein said guiding channel is located at the respective base by connecting in space both end surface of the base, one end of the position pillar being located at the carrier disc while another end thereof penetrates the guiding channel to engage a position hole at the pairing disc.

6. The centrifugal magnetic heating device according to claim 4, wherein said plurality of position pillars are mounted at end surfaces of the bases, the plurality of guiding channels are located between the carrier disc and the pairing disc to accommodate thereinside the respective position pillars.

7. The centrifugal magnetic heating device according to claim 3, wherein said position resuming member is formed as a position resuming spring having a first end and a second end to be fixed to the different bases so as to generate an elastic pulling for elastically pulling closely the bases and the transmission shaft.

8. The centrifugal magnetic heating device according to claim 3, wherein said position resuming member is formed as a position resuming spring having a first end fixed at the base and a second end fixed at the transmission shaft.

9. The centrifugal magnetic heating device according to claim 3, wherein said position resuming member is formed as a V-shape or Ω-shape spring plate, having a central tip and two opposing ends fixed respectively to the different neighboring bases, the base being pushed elastically to contact solidly onto the transmission shaft along the direction towarding the transmission shaft by providing elasticity and stiffness of the spring plate.

10. The centrifugal magnetic heating device according to claim 3, wherein said position resuming member is formed as a magnetic guiding structure; by providing magnetic attraction of the magnetic guiding structure, the bases being elastically depressed onto the transmission shaft along the direction towarding the transmission shaft; in which the magnetic guiding structure is formed as one of the following: locating at least one permanent magnet to each of the neighboring bases with different magnetic poles (N poles or S poles), locate corresponding permanent magnets to the adjacent ends of the neighboring bases with different magnetic poles (N poles or S poles), while at the other ends of the bases 122 magnetic blocks are mounted; and having the base made of a magnetic material and having the neighboring bases to have different magnetic polarity (N poles or S poles).

11. The centrifugal magnetic heating device according to claim 1, wherein said conductive member further has an water inlet and a water outlet for flowing in and out of a fluid inside the conductive member, the conductive member is any one of the following structures: one that has a laminar-plate or spiral-fin interior, one that has a rectangular circulating piping, and one that has round circulating piping; the conductive member being made of a material selected from the group including a copper, an aluminum, an iron, and an alloy.

12. The centrifugal magnetic heating device according to claim 1, wherein said centrifugal mechanism further includes at least a magnet frame mounted on the bases for installing the permanent magnets; the permanent magnets being shaped as one of round, trapezoidal, triangular, polygonal, and any irregular-cross sectional cylindrical shape; an arrangement of the permanent magnets on the bases being one of an arrangement of having plural sets of the permanent magnets to surround exteriorly the bases along the central axial direction in a symmetric, horizontal and parallel manner, an arrangement of having a helix set of the permanent magnets to surround exteriorly the bases along the central axial direction in a twist manner, and an arrangement of having plural sets to surround exteriorly the bases along the central axial direction in an asymmetric and helix manner.

13. The centrifugal magnetic heating device according to claim 2, further including a heat storing apparatus having an input junction and an output junction to connect the water jacket member at the water outlet and the water inlet, respectively; so as to establish an internal circulation of the fluid.

14. The centrifugal magnetic heating device according to claim 13, further including a heat conductive member mounted inside the heat storing apparatus for transferring the heat generated in the heat generator to the heat storing apparatus, the heat conductive member mainly including a heat dissipation manifold having a plurality of external heat-dissipating fins, two ends of the heat dissipation manifold being in fluid communication with the heat generator so as to establish an internal heat circulation in between.

15. The centrifugal magnetic heating device according to claim 14, wherein said heat conductive member is to directly heat up a plurality of to-be-heated districts; the to-be-heated districts being one of a building and a water tank.

16. The centrifugal magnetic heating device according to claim 13, further including an auxiliary circulation device for promoting the circulation of the fluid flowing between the water jacket member and the heat storing apparatus, the auxiliary circulation device being one of a wind pump and an electric pump located at a predetermined position at the output junction of the heat storing apparatus.

17. The centrifugal magnetic heating device according to claim 13, further including a solar water heater having two internal piping to form a fluid-communication connection with the heat storing apparatus.

18. The centrifugal magnetic heating device according to claim 13, further including an auxiliary heating device further having a temperature detector, a controller and a heater, both the temperature detector and the heater being mounted on the heat storing apparatus and electrically coupled with the controller, the temperature detector being to detect if a temperature inside the heat storing apparatus is low enough to activate the controller to further process a heating procedure of the heater upon the heat storing apparatus.

19. The centrifugal magnetic heating device according to claim 4, wherein said centrifugal magnetic heating device has two said bases, the guiding channels are located to both end surfaces of the bases, one end of each said position pillar is mounted at the carrier disc while another end penetrates the respective guiding channel, and each of the bases has an individual pivotal hole; a location of the pivotal hole of one said base being right next to the guiding channel of the other base, the carrier disc further including two pivotal pillars to penetrate the corresponding pivotal holes of the bases; when the transmission shaft rotates to drive the carrier disc and the two bases, each said base being affected by an induced centrifugal forcing to swing away about a respective pivotal pair formed by the pivotal pillar and the pivotal hole; while in rotation, the position pillar in the other guiding channel of the base sliding along a width direction of the guiding channel so as to pull the position resuming member and thus to generate a resilient position resuming contraction force.

20. The centrifugal magnetic heating device according to claim 19, wherein said position resuming member has an end to be engaged in the respective pivotal hole.
